(19) United States
(12) Patent Application Publication
(10) Pub. No.: US 2019/0230317 A1
(43) Pub. Date: Jul. 25, 2019

(54) Immersive mixed reality snapshot and video clip

(71) Applicant: Blueprint Reality Inc., Vancouver (CA)

(72) Inventors: Benjamin James Sheftel, Vancouver (CA); Tryon Williams, West Vancouver (CA)

(21) Appl. No.: 15/879,432

(22) Filed: Jan. 24, 2018

(51) Int. Cl. H04N 5/92; G06T 19/00; G06F 3/01; G02B 27/01

(52) U.S. Cl. CPC H04N 5/9205; G06T 19/003; G02B 27/017; G06F 3/011; G06T 19/006

(57) ABSTRACT

An immersive computing machine makes a recording of an immersive MR scene. The recording includes sufficient data to reconstruct multiple different three-dimensional views of the scene depending on a perspective of a viewer using another immersive computing machine. One or multiple viewers may enter a playback of the recorded immersive scene and make further immersive recordings. The scene may be a still or a motion scene. The immersive recording is transmitted with a two-dimensional version of the recording that can be viewed on a non-immersive device, which can add the three-dimensional immersive recording to a queue for later viewing on an immersive device.

### TECHNICAL FIELD

This application relates to the field of computer-altered image and video production. In particular, it relates to mixed reality (MR) snapshots and video recordings that provide an immersive experience for an observer, and a method and system for creating them.

### BACKGROUND

Virtual Reality (VR) and Augmented Reality (AR) can provide the most engaging form of digital media for users to consume. Immersive computing systems tend, however, to be isolating or exclusionary as they produce content that is experienced by a single user only. This output is difficult to express on 2D display devices, such as smart phones, televisions and web browsers, and is also difficult to express to other users who are using an immersive computing system. Nevertheless, the most shareable content generated from a VR/AR experience will, for the foreseeable future, be accessible as 2D media accessed through 2D computing platforms, such as smartphones, personal computers, TV, etc.

The current standard for visually communicating immersive experiences is to reuse the visual rendering of the virtual scene, which is sent to a headset to provide the immersive experience. However, the visual rendering output poses a number of problems from the standpoint of communication to the other person. For example, fast, erratic headset movement is expected, which is driven by the wearer's movement, specifically head rotation. This leads to transmission of a fast and erratic video to the recipient. This may also be the case with users who communicate their immersive experience from a headset enabled for augmented reality.

This background is not intended, nor should be construed, to constitute prior art against the present invention.

### SUMMARY OF INVENTION

Real-time content, including real subjects and digital assets, is generated and recorded for 2D/3D mixed-media output. The content can be consumed in multiple phases, on 2D and 3D devices. The content can also be remixed to create further content.

The combination of a 2D image and the 3D immersive MR snapshot to which it corresponds represents a new form of media that combines the accessibility of graphical 2D content with the engagement of immersive content. The resulting mixed media snapshot can be consumed in phases by a user through one or more computing devices. Similarly, the combination of a 2D video clip and the 3D immersive MR video clip to which it corresponds also represents a new form of media that combines the accessibility of 2D video content with the engagement of immersive content. Again, the resulting mixed media video can be consumed in phases by a user through one or more computing devices.

Multiple users, using communications technology that enables them to join each other in VR and AR environments, can call each other live if they are online at the same time, and together relive an experience that one of them had previously recorded.

Disclosed herein is a method for experiencing immersive mixed reality (MR) content comprising the steps of: receiving a recording of an immersive MR scene, wherein the recording comprises sufficient data to reconstruct multiple different three-dimensional views of the immersive MR scene depending on a perspective of a viewer of the reconstructed immersive MR scene; displaying the immersive MR scene to the viewer on an immersive device connected to an immersive computing system; and adjusting the display of the immersive MR scene from a first perspective to a second perspective as the viewer moves from a first location to a second location in the immersive MR scene.

In some embodiments, the immersive MR scene includes a recording of a subject, and the method further comprises displaying the immersive MR scene to the subject on a further immersive device connected to a further immersive computing system, simultaneously with the displaying of the immersive MR scene to the viewer; wherein the display of the immersive MR scene to the viewer includes a composited live view of the subject, and the display of the immersive MR scene to the subject includes a composited live view of the viewer.

Also disclosed herein is a non-transitory computer readable medium comprising computer-readable instructions, which, when executed by a processor cause an immersive computing machine to: receive a recording of an immersive mixed reality (MR) scene, wherein the recording comprises sufficient data to reconstruct multiple different three-dimensional views of the immersive MR scene depending on a perspective of a viewer of the reconstructed immersive MR scene; display the immersive MR scene to the viewer on an immersive device connected to an immersive computing machine; and adjust the display of the immersive MR scene from a first perspective to a second perspective as the viewer moves from a first location to a second location in the immersive MR scene.

Further disclosed herein is a system for providing experiences of immersive mixed reality (MR) content comprising an immersive computing machine, an immersive device connected to the immersive computing machine, and a processor configured to: receive a recording of an immersive MR scene, wherein the recording comprises sufficient data to reconstruct multiple different three-dimensional views of the immersive MR scene depending on a perspective of a viewer of the reconstructed immersive MR scene; display the immersive MR scene to the viewer on the immersive device; and adjust the display of the immersive MR scene from a first perspective to a second perspective as the viewer moves from a first location to a second location in the immersive MR scene.

### BRIEF DESCRIPTION OF DRAWINGS

The following drawings illustrate an embodiment of the invention, and should not be construed as restricting the scope of the invention in any way. The drawings are not to scale.

FIG. 1 is a schematic diagram of a mixed media system for creating immersive MR snapshots and video clips, according to an embodiment of the present invention.

FIG. 2 is a schematic diagram of a user viewing an immersive MR snapshot from two different angles.

FIG. 3 is a schematic diagram of a user viewing an immersive MR video clip, according to an embodiment of the present invention.

FIG. 4 is a schematic diagram of a two users simultaneously experiencing an immersive MR snapshot.

FIG. 5 is a flowchart of the main steps for one user experiencing an immersive MR scene that has been recorded of another user, according to an embodiment of the present invention.

FIG. 6 is a flowchart of the main steps for two users to experience an immersive MR scene that has been recorded with one of the users in it, according to an embodiment of the present invention.

FIG. 7 is a flowchart of the main steps for consuming a mixed media MR scene, according to an embodiment of the present invention.

FIG. 8 is a schematic representation of data representing different viewing modes of an immersive MR snapshot, according to an embodiment of the present invention.

### DESCRIPTION

### A. Glossary

The term “augmented reality (AR)” refers to a view of a real-world scene that is superimposed with added computer-generated detail. The view of the real-world scene may be an actual view through glass, on which images can be generated, or it may be a video feed of the view that is obtained by a camera.

The term “virtual reality (VR)” refers to a scene that is entirely computer-generated and displayed in virtual reality goggles or a VR headset, and that changes to correspond to movement of the wearer of the goggles or headset. The wearer of the goggles can therefore look and “move” around in the virtual world created by the goggles.

The term “mixed reality (MR)” refers to the creation of a video or photograph of real-world objects in a virtual reality scene. For example, an MR video may include a person playing a virtual reality game composited with the computer-generated scenery in the game that surrounds the person. An immersive MR scene is one that an observer can move around in and view from different perspectives within the scene, the scene changing in accordance with the perspective of the observer. An immersive MR scene may be a still or a motion scene.

The term “mixed media” refers to a recording of a scene that has at least two components. One component is for viewing the scene as a 2D snapshot or video, and another component is for viewing the scene as an immersive, digital 3D hologram or holographic video.

An “immersive device” refers to a VR or AR headset, goggles or other device that can provide an immersive environment to the user of the immersive device.

A “non-immersive device” does not provide an AR or VR environment to the user of the non-immersive device, and includes devices such as laptops, smartphones and tablets.

The term “processor” is used to refer to any electronic circuit or group of circuits that perform calculations, and may include, for example, single or multicore processors, multiple processors, an ASIC (Application Specific Integrated Circuit), and dedicated circuits implemented, for example, on a reconfigurable device such as an FPGA (Field Programmable Gate Array). The processor performs the steps in the flowcharts, whether they are explicitly described as being executed by the processor or whether the execution thereby is implicit due to the steps being described as performed by code or a module. The processor, if comprised of multiple processors, may be located together or geographically separate from each other. The term includes virtual processors and machine instances as in cloud computing or local virtualization, which are ultimately grounded in physical processors.

The term “system” without qualification refers to the invention as a whole, i.e. a system for creating and displaying mixed media MR snapshots and video clips. The system may include or use sub-systems.

The term “user” refers to a person who uses the system for creating or experiencing mixed media immersive content. A user may use either a non-immersive, conventional device (e.g. smartphone or tablet) or a VR/AR device, which provides an immersive computing environment. For example, a user could be a player engaging in a virtual reality game. A user can be a subject of immersive content or a viewer of the immersive content, or both.

The term “chroma keying” refers to the removal of a background from a video that has a subject in the foreground. A color range in the video corresponding to the background is made transparent, so that when the video is overlaid on another scene or video, the subject appears to be in the other scene or video.

### B. Exemplary System

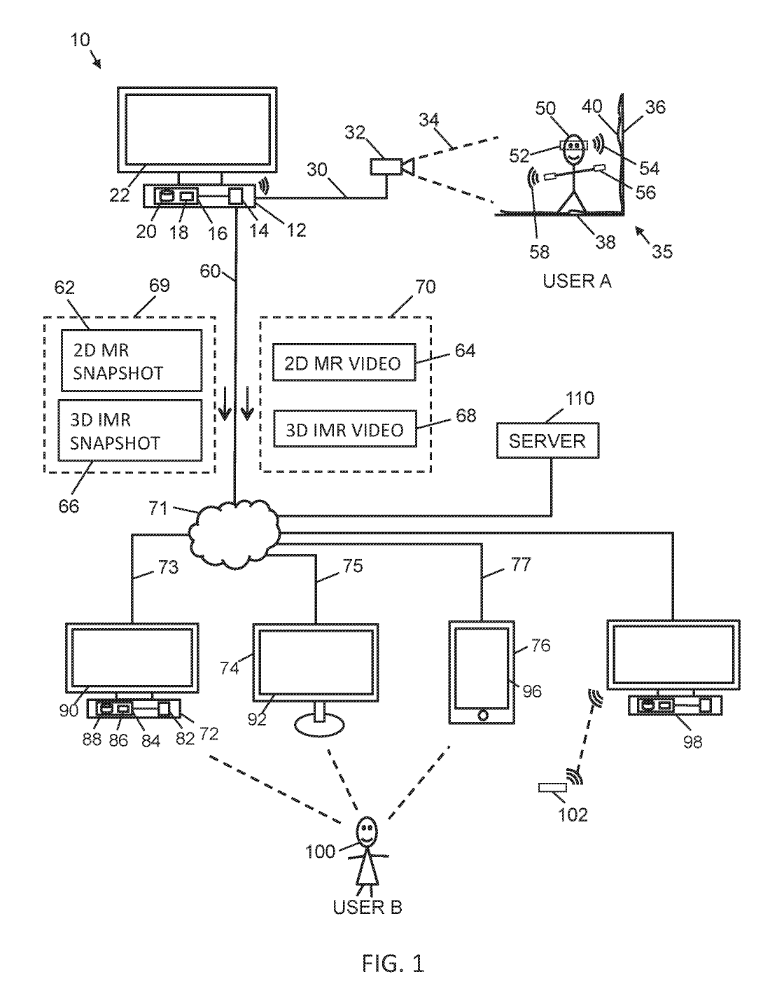

Referring to FIG. 1, there is shown an exemplary system 10 for creating mixed media MR snapshots and video clips. The system 10 includes or interacts with an immersive processor such as a gaming machine 12. In other embodiments, the immersive processor may be a desktop computer, a laptop or a tablet, for example, or any other electronic device that is equipped with immersive devices or features to provide the necessary equivalent functionality of an immersive processor. The gaming machine 12 includes one or more processors 14 which are operably connected to non-transitory computer readable memory 16 included in the device. The gaming machine 12 includes computer readable instructions 18 (e.g. an application) stored in the memory 16 and computer readable data 20, also stored in the memory. Computer readable instructions 18 may be broken down into blocks of code or modules. The memory 16 may be divided into one or more constituent memories, of the same or different types. The gaming machine 12 optionally includes a display screen 22, operably connected to the processor(s) 14. The display screen 22 may be a traditional screen, a touch screen, a projector, an electronic ink display or any other technological device for displaying information.

The gaming machine 12 is connected via a wired or wireless connection 30 to a camera 32 or device acting as a camera. Multiple cameras may be used in some embodiments, and they may either be 2D or 3D cameras. Some embodiments may use a secondary processing device with a camera, which transmits the camera video feed back to the gaming machine 12 or other immersive processor. The camera 32 is directed such that its field of view 34 captures a background set 35. In this example, the background set 35 includes a wall 36 and floor 38, both covered with a green cloth 40 or other green screen. A user, in this case an immersive User A 50, is present in the background set 35, and is wearing a virtual reality headset 52 that is wirelessly connected 54 to the gaming machine 12. Alternately, the headset 52 is connected with a wired connection to the gaming machine 12. In other embodiments, User A may wear AR goggles or may use a phone-based AR device. User A is also holding controls 56, which are also wirelessly connected 58 to the gaming machine 12. Under control of the processor 14 executing the application 18, the VR headset 52 displays to User A a view of a virtual scene that is either stored as part of data 20, or created on the fly from digital assets that are stored as data.

The scene viewed by the camera 32 is chroma keyed to remove the green screen background and to add User A to a computer-generated virtual scene. A recording of this virtual scene, with User A added, is saved as 2D MR snapshot 62, a 2D MR video clip 64, a 3D immersive MR snapshot 66 and/or a 3D immersive MR video clip 68. The 2D MR snapshot 62 is a flat, still digital photograph of User A in a still representation of the computer generated virtual scene at the time of capture. The 2D MR video clip 64 is a flat video recording of User A in the computer generated virtual scene. The 3D immersive MR snapshot 66 is like a digital still hologram of User A in the computer generated virtual scene. The 3D immersive MR snapshot 66 can be viewed from different angles to provide different perspectives, and can be virtually entered by another user who is wearing the necessary VR headset connected to a gaming machine or other immersive processor. The 3D immersive MR video clip 68 is a digital motion hologram of User A in a moving representation of the computer generated virtual scene at the time of capture. Likewise, the 3D immersive MR video clip 68 can be viewed from different angles to provide different perspectives to a viewer, and can be virtually entered by the viewer or another user who is wearing the necessary VR headset connected to a gaming machine or other immersive processor.

In some embodiments, the recordings of the 2D MR snapshot 62 and the 3D immersive MR snapshot 66 are combined as one set of data forming mixed media 69 representing different viewing modes of a still MR scene. In some embodiments, the recordings of the 2D MR video clip 64 and the 3D immersive MR video clip 68 are combined as another set of data forming mixed media 70 representing different viewing modes of an MR motion scene. In further embodiments, a 2D MR snapshot is included with mixed media 70, or a particular frame of the 2D MR video is selected as the 2D MR snapshot.

The recordings of a 2D MR snapshot 62, a 2D MR video clip 64, a 3D immersive MR snapshot 66 and/or a 3D immersive MR video clip 68 are triggered by User A 50 or automatically by the software 18 in the gaming machine 12 having detected that one or more conditions have been met.

The recordings 62, 64, 66, 68 are transmitted via wired or wireless communications link 60, through a network 71 such as the internet, a cellular network or a combination of both, to one or more devices capable of 2D display. Such devices may be a computer 72 connected to the network by communications link 73, a television 74 connected to the network by communications link 75 and/or a smartphone 76 connected to the network by communications link 77.

The computer 72 includes one or more processors 82 which are operably connected to non-transitory computer readable memory 84 included in the computer. The computer 72 includes computer readable instructions 86 (e.g. an application) stored in the memory 84 and computer readable data 88, also stored in the memory. Computer readable instructions 86 may be broken down into blocks of code or modules. The memory 84 may be divided into one or more constituent memories, of the same or different types.

The computer 72 has a screen 90 on which is displayed the 2D MR snapshot 62 and 2D MR video 64. The 2D MR snapshot 62 and 2D MR video 64 can also be displayed on the screen 92 of the television 74 and/or the screen 96 of the smartphone 76. User B 100 can then view the 2D MR snapshot 62 and/or 2D MR video 64 on whichever of the computer 72, television 74 and smartphone 76 that she has access to.

When User B 100 is using a gaming machine 98 to view the mixed media snapshot 69, she may choose or have chosen to activate the 3D immersive MR snapshot component 66 that is associated with it. In this situation, she wears a VR headset 102 that is connected to the gaming machine 98. When observing the 3D immersive MR snapshot 66 via the headset 102, User B can enter the MR scene that was previously recorded, and, to a limited extent, move around in it and observe the recording of the scene and User A from different angles.

Likewise, if User B 100 uses a gaming machine 98 to view the mixed media video clip 70, she may choose or have chosen to activate the 3D immersive MR video clip 68 component that is associated with it. Again, she wears a VR headset 102 that is connected to the gaming machine 98. When observing the 3D immersive MR video clip 68 via the headset 102, User B can enter the MR scene that was previously recorded, move around in it to a limited extent, and observe the recording of User A from different angles, performing the actions and motions that he had previously performed. The 3D immersive MR video clip 68 generates the scene-appropriate VR or AR reactions and effects in real time as the 3D immersive video clip is played, just as they had been generated when User A was interacting with the virtual world.

When User B 100 receives a recording 62, 64, 66, 68 on a 2D device 72, 74, 76, she can save or mark the recording for later consumption of the 3D immersive snapshot 66 or 3D immersive video clip 68 on an immersive or other 3D-capable device or system, such as a gaming machine 98 connected with VR or AR headset 102. Recordings 62, 64, 66, 68 can be stored on a server 110 for future access.

The system 10 therefore allows previous experiences of real people to be shared via non-immersive 2D devices 72, 74, 76 and immersive devices 98. Other users can see their experience as a photo or video, and also as a re-enactment, and they can then stand and walk around and experience it in full presence.

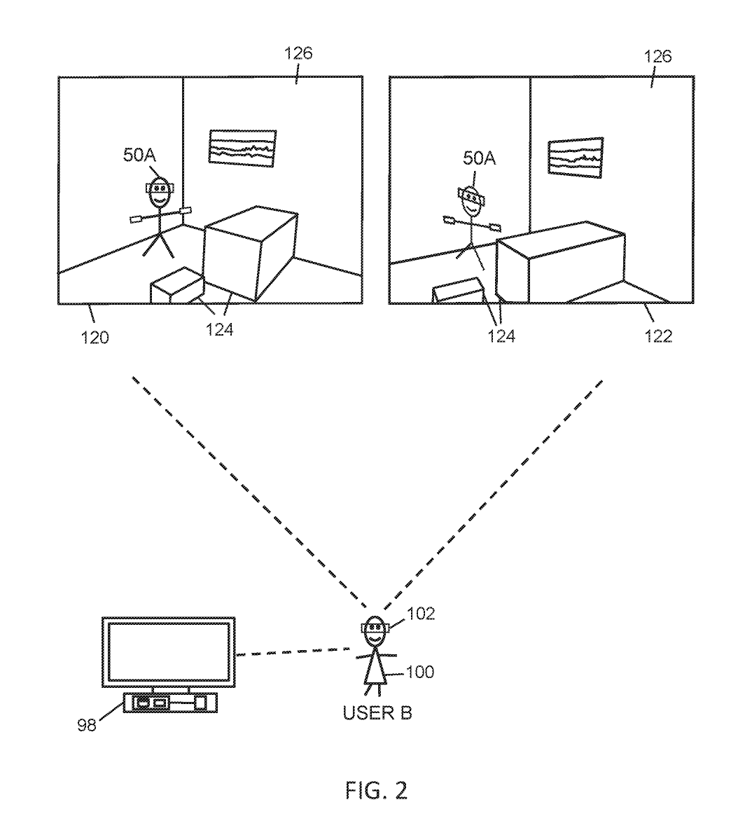

Referring to FIG. 2, User B 100 is shown wearing headset 102 connected to gaming machine 98. User B is viewing a 3D immersive MR snapshot 66, and can move around in it to view it from two different angles 120, 122. The 3D immersive MR snapshot 66 includes a 3D image 50A of User A and virtual assets 124 in a virtual room 126.

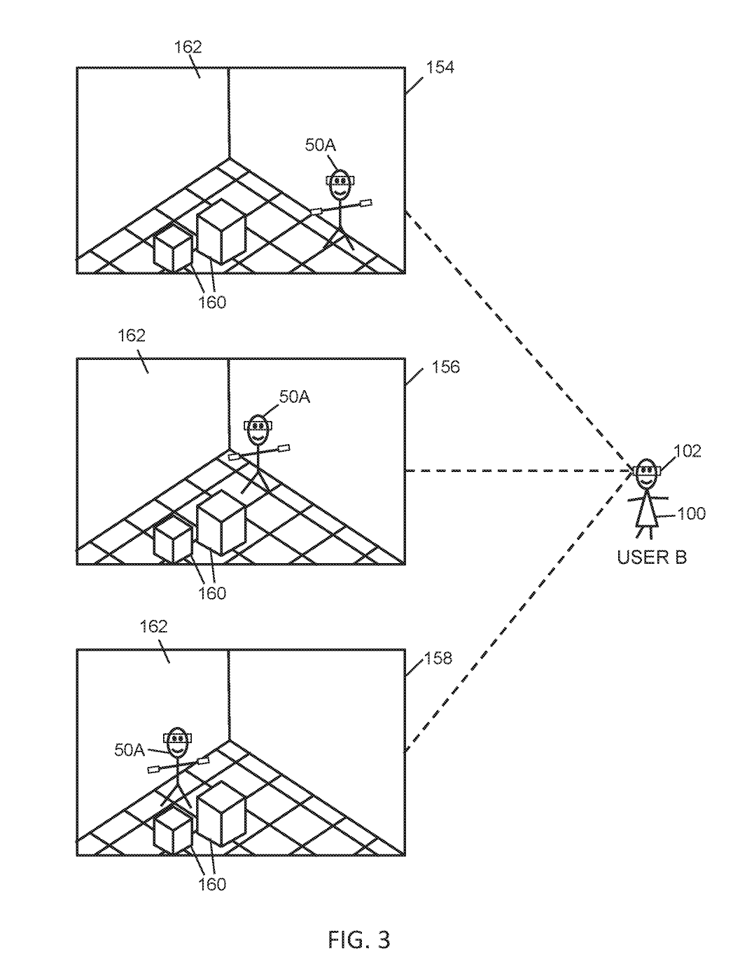

Referring to FIG. 3, User B 100 is wearing headset 102 connected to gaming machine 98 (not shown). User B is viewing a 3D immersive MR video clip 68, and three different frames 154, 156, 158 of the video are shown. The 3D immersive MR video clip 68 includes a 3D moving image 50A of User A and virtual assets 160 in a virtual room 162. User B can also move around in the 3D immersive MR video clip 68 to view it from different angles, while the video clip is being played back.

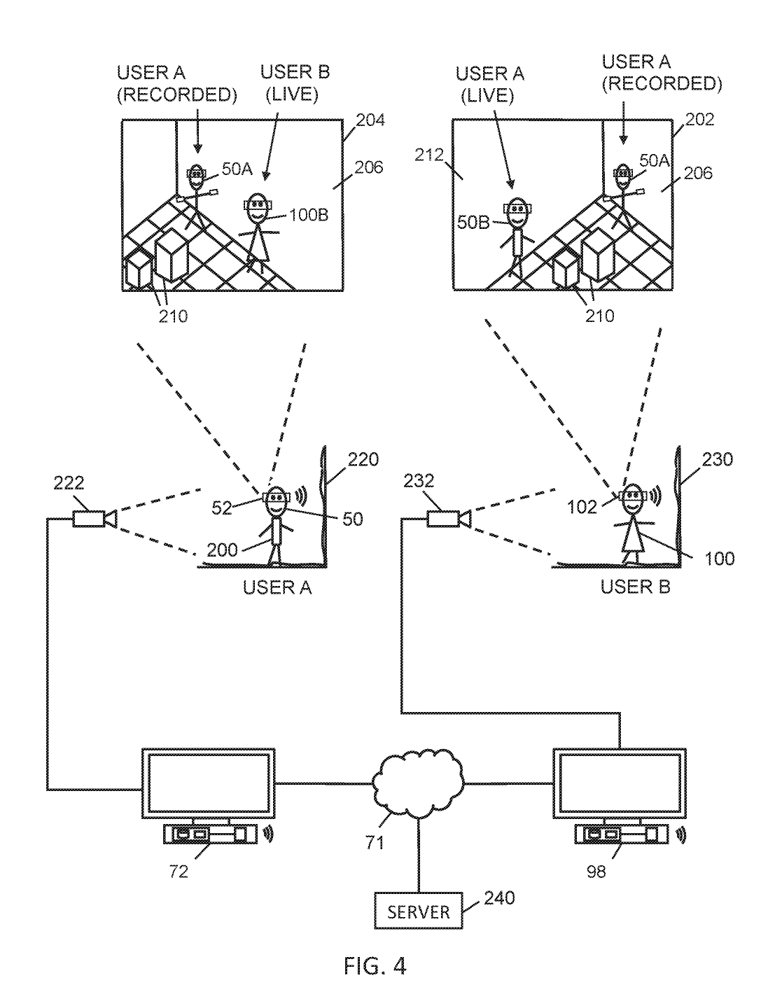

Referring to FIG. 4, a 3D immersive MR snapshot 66 of User A is being shown back to both User A 50 and User B 100 simultaneously via separate immersive devices 72, 98 respectively. User A 50 is shown with different clothing 200 to distinguish him from the prior recording 50A of himself. Moving to User B 100 on the right side of FIG. 4, she is wearing a headset 102 that is wirelessly connected to a gaming machine 98. A view 202 of the previously recorded MR scene is being displayed to her via her headset 102. The view 202 includes a recorded image 50A of User A in a virtual room 206 with virtual assets 210. Since User B 100 has invited User A 50 to experience the immersive MR snapshot 66 with her, she also sees a live image 50B of User A in the scene.

User A 50 is in a green screen set 220 being recorded by camera 222, which is connected to gaming machine 72 or other immersive computing machine. The immersive computing machine 72 composites an image of User A 50 into the 3D immersive MR snapshot 66 and transmits it via network 71 to User B's immersive computing machine 98, for display in User B's headset 102. As a result, User B sees a live 3D image 50B of User A in the immersive 3D snapshot that she is experiencing. The display in User B's headset 102 is presented from a perspective of the location of User B in the 3D immersive snapshot 66.

In a similar way, User A sees a live, 3D image 100B of User B. User B 100 is in a green screen set 230 being recorded by camera 232, which is connected to gaming machine 98 or other immersive computing machine. The immersive computing machine 98 composites an image of User B 100 into the 3D immersive MR snapshot 66 and transmits it via network 71 to User A's immersive computing machine 72, for display in User A's headset 52. As a result, User A sees a live 3D image 100B of User B in the immersive 3D snapshot that he is experiencing. Users A and B can see live images of each other moving around in the 3D immersive snapshot, but cannot see any part of themselves. However, in some embodiments, users could see themselves if 2D or 3D video projections were used to position them in the place were they are in the immersive 3D snapshot. In further embodiments, users can see live images of themselves from the first person view. A server 240 may be used to coordinate the communication between the two gaming machines 72, 98, and to provide a voice channel between Users A and B so that they can communicate in real time.

The same set-up can be used for Users A and B experiencing a 3D immersive MR video clip 68. The video clip 68 can be played back at normal speed as recorded, paused, slowed down or sped up, or scrubbed through, while at the same time the 3D live images 50B, 100B of User A and User B respectively are displayed to each other in real time, subject of course to any normal latency of the system.

The compositing of the real images into the virtual scenes may occur at either of the transmitting or receiving gaming machines 72, 98 or at the server 240.

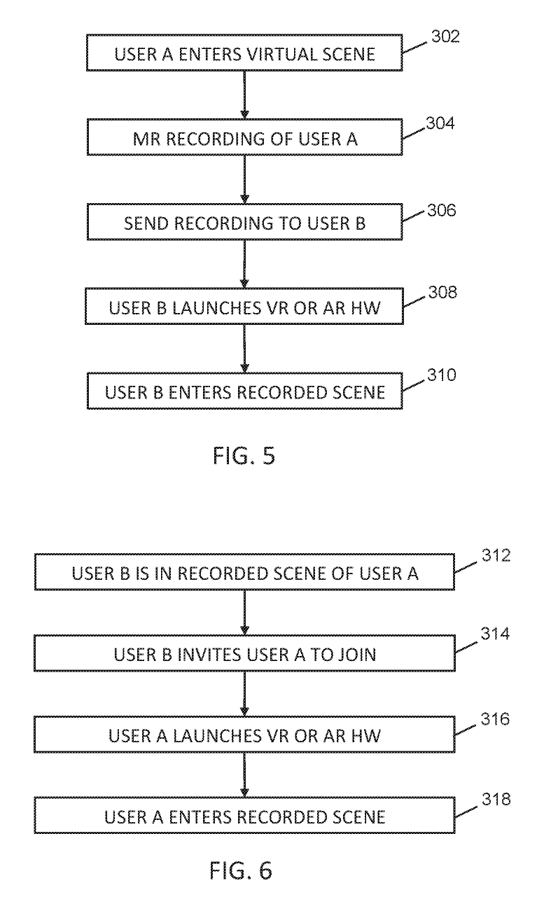

Referring to FIG. 5, a method is shown for one user experiencing an immersive MR scene that has been recorded by another user. The scene is an immersive representation of a still or a motion scene. In step 302, User A enters a virtual scene created by an immersive computing device. In step 304, the immersive computing device makes an immersive MR recording of User A in the VR scene. The recording may be a snapshot or a video clip. The immersive computing device may automatically make the recordings or make one long continuous recording. The recordings may be initiated when User A instructs the system to make a recording, or when the immersive computing system detects that User A has reached a certain threshold in a VR game, or when the immersive computing system detects certain actions that User A makes. Recordings may be made continuously, and the last few seconds saved when a certain action, motion or achievement of User A is detected.

In step 306, the immersive computing system sends the recording to User B. The recording may be sent as a whole, or with only the parts sufficient for its recreation on the immersive computing device of User B. This is because the immersive computing device of User B may already have some or all of the digital assets that are present in the recorded scene, and may only need to be instructed where to position them or to have their state driven more procedurally.

In step 308, User B receives the recording and launches the display of the recording on an immersive VR or AV computing device. User B then, in step 310, enters the recorded scene, and can move around in it to the extent of the limits of the perspectives available to User B.

Referring to FIG. 6, shown is a method performed by the system to allow two users to experience an MR scene that has previously been recorded with one of the users in it. The method starts in step 312, with User B experiencing the recorded scene, which is of User A. User B then, in step 314, invites User A to join the scene. In response, User A launches his VR or AR immersive computing machine in step 316, and then enters the recorded scene in step 318. At this point, both User A and User B are simultaneously in the recorded scene, and can see each other moving around in the scene.

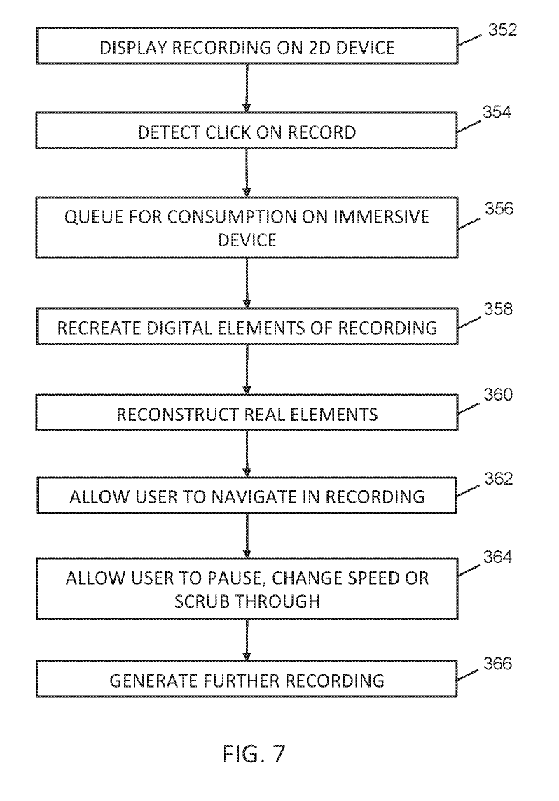

Referring to FIG. 7, a method is shown for one user experiencing both the 2D and 3D components of a mixed media MR scene that has been recorded by another user. The scene may be a still or a motion scene and includes both a 2D representation and a 3D immersive representation of the scene. In step 352, the system displays the 2D component of the recording on a non-immersive device with a 2D screen, such as a laptop computer or smartphone (e.g. 72, 74, 76). The display of the 2D component may be triggered, for example, by the user clicking on a thumbnail of the 2D component.

In step 354, the system detects a click related to the displayed 2D recording, which signifies that the user wants to view the 3D immersive component of the recording. In other embodiments, other techniques may be used to signify to the system that the user wishes to view the 3D immersive component. In step 356, the system 10 queues the recording for consumption on an immersive device 98 later on, at the user's convenience.

When the user wishes to view the 3D immersive recording using an immersive device, the system 10 recreates the digital elements of the recording in step 358, and reconstructs the real elements of the recording in step 360. The digital and real elements are then displayed to the user as a full, 3D immersive MR scene.

The digital elements of the recording are recreated in the state they were in when the recording was generated. This recreation can be an approximation, and does not require the elements of the scene to retain their logical functionality from the original application. The real elements are reconstructed in the scene with spatial approximation. Depending on the data, this approximation can use device tracking information or physical camera data, such as pixel depth, to determine where the real elements are placed and visualized.

In step 362, the system then allows the user to navigate in the recording. The user is free to navigate through the scene spatially, using standard immersive tracking processes, and experience it from any angle, albeit positionally constrained to an area around the original user.

The recording can be experienced at its original rate of animation. However, in step 364, the system allows the user to pause, change the speed of and/or scrub through the recording. In step 366, the system 10 generates a further recording, this time including the user added to the previously recorded scene. By this, the user contributes an additive variation of the source content, i.e. a remix.

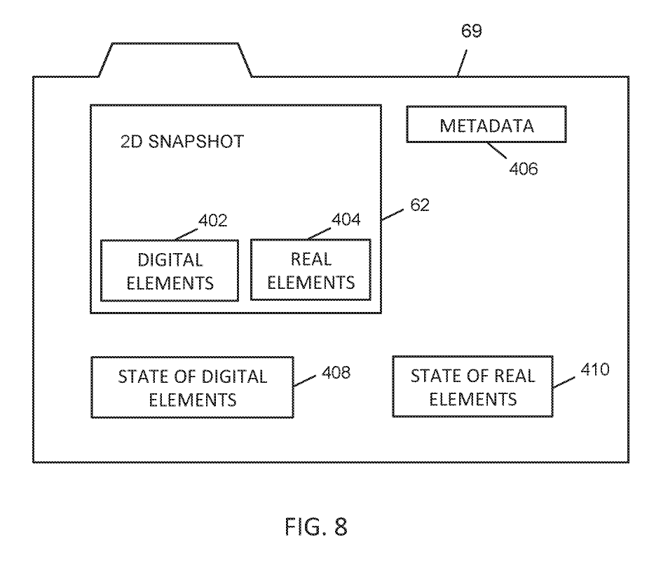

FIG. 8 shows the elements of a mixed media still recording 69, which includes 2D snapshot 62 and immersive 2D MR snapshot 66. The mixed media 69 includes a 2D image 62. The 2D image is composed of both digital elements 402, such as parts of a virtual room and virtual furniture, and real elements 404, such as an image of a user composited into the image. The mixed media recording 69 includes metadata 406, which includes the time the recording was created, the source application, the participants in the scene, hardware information and tracking data etc. If the source device is AR rather than VR, geospatial data may be included to reconstruct the surrounding environment on viewing. Also included in the recording 69 is data representing the state of the digital elements, such as the virtual camera's intrinsic properties (field of view, distortion, etc.); camera's coordinate information; and the scene state data (time, active meshes, etc.). The exact data required for state recreation may vary from application to application. The recording also includes data representing the state of the real elements, such as RGB image(s); intrinsic properties of the physical camera (field of view, distortion, etc.); coordinate information for the physical camera; and optionally depth information. As it can be seen in this embodiment, the complete data as it is to be rendered is not included in the recording 69, but instead only the data that is sufficient to recreate the scene is included.

A mixed media motion recording 70 includes a series of still recordings 69, or the data equivalent to that of a series of still recordings. Compression techniques may be used to reduce the storage and bandwidth requirements of a motion recording.

### D. Variations

While the present embodiment describes the best presently contemplated mode of carrying out the subject matter disclosed and claimed herein, other embodiments are possible.

The recordings can be created from any MR experience, thus enabling any VR or AR experience for which MR is being created to become what is effectively a cross-platform and cross-reality hyperlink. VR users, when viewing an AR-generated recording, may be shown an approximation of the real world location where the recording was generated. AR users, when viewing a VR-generated recording, may be shown a subset of the digital objects, as the full background cannot be rendered effectively.

Wherever a camera is referenced, multiple cameras may be used instead, and they may be either 2D or 3D cameras. A computer process may govern how the data from these multiple sources can be combined to produce a coherent and accurate representation of their subject.

For technical simplicity or user convenience, the system viewing logic used to display the recordings may install and launch the same application that created the recordings in the first place, in order to reuse digital and real assets. The same application may also be used to allow additional interaction by the user who is viewing the recording. For example, a further interaction provided to the user may be a method to purchase the title that generated the MR recording.

The real components of the MR scenes may be human, animal and/or inanimate objects. The data used to describe the real components (the subject) can include a number of sources. These sources may be combined in such a way as to maximize the visual quality of the subject to the viewer. One such example is a 3D digital approximation of the present humans. These representations may have been pre-generated and customized by the user, or created procedurally using available data. These “characters” can be posed given tracking data to produce likenesses of the user at a moment in time. Another example is raw or processed camera input data being shown on a rectangular mesh, whose dimensions and position are governed by provided tracking data. If the camera provides depth data, this mesh may be deformed by it to more accurately represent the subject when viewed from certain angles.

In some embodiments, the mixed media video includes a 3D immersive MR video and a 2D MR snapshot, but not a 2D MR video.

In other embodiments, more than two users can enter the immersive snapshot or video.

While the green screen has been described as being green, other colors are also possible for the background screen. Alternative background removal methods may be employed instead of chroma keying. One example is accessing depth data for each pixel from a depth-sensing camera and discarding pixels of the camera feed behind the player, who is in the foreground. Another is by pre-sampling the background colors in the camera feed and discarding pixels that are similar to that sample. Another method is static subtraction. The main requirement is that the background be digitally removable from a video of a subject in the foreground.

The mixed media that are transmitted may include audio, or the audio may be transmitted in a separate audio connection. The audio source may be represented positionally during consumption of the media, if the microphone position is determinable.

In general, unless otherwise indicated, singular elements may be in the plural and vice versa with no loss of generality.

Throughout the description, specific details have been set forth in order to provide a more thorough understanding of the invention. However, the invention may be practiced without these particulars. In other instances, well known elements have not been shown or described in detail and repetitions of steps and features have been omitted to avoid unnecessarily obscuring the invention. For example, known details of standard MR broadcasting from VR or AR hardware have been excluded. Accordingly, the specification and drawings are to be regarded in an illustrative, rather than a restrictive, sense.

The detailed description has been presented partly in terms of methods or processes, symbolic representations of operations, functionalities and features of the invention. These method descriptions and representations are the means used by those skilled in the art to most effectively convey the substance of their work to others skilled in the art. A software implemented method or process is here, and generally, understood to be a self-consistent sequence of steps leading to a desired result. These steps require physical manipulations of physical quantities. Often, but not necessarily, these quantities take the form of electrical or magnetic signals or values capable of being stored, transferred, combined, compared, and otherwise manipulated. It will be further appreciated that the line between hardware and software is not always sharp, it being understood by those skilled in the art that the software implemented processes described herein may be embodied in hardware, firmware, software, or any combination thereof. Such processes may be controlled by coded instructions such as microcode and/or by stored programming instructions in one or more tangible or non-transient media readable by a computer or processor. The code modules may be stored in any computer storage system or device, such as hard disk drives, optical drives, solid state memories, etc. The methods may alternatively be embodied partly or wholly in specialized computer hardware, such as ASIC or FPGA circuitry.

It will be clear to one having skill in the art that further variations to the specific details disclosed herein can be made, resulting in other embodiments that are within the scope of the invention disclosed. Steps in the flowcharts may be performed in a different order, other steps may be added, or one or more may be removed without altering the main function of the system. Flowcharts from different figures may be combined in different ways. Configurations described herein are examples only and actual values of such depend on the specific embodiment. Accordingly, the scope of the invention is to be construed in accordance with the substance defined by the following claims.

1. A method for experiencing immersive mixed reality (MR) content comprising the steps of:
receiving a recording of an immersive MR scene, wherein the recording comprises sufficient data to reconstruct multiple different three-dimensional views of the immersive MR scene depending on a perspective of a viewer of the reconstructed immersive MR scene;
displaying the immersive MR scene to the viewer on an immersive device connected to an immersive computing system; and
adjusting the display of the immersive MR scene from a first perspective to a second perspective as the viewer moves from a first location to a second location in the immersive MR scene.

2. The method of claim 1, wherein the recording includes a two-dimensional (2D) image of the immersive MR scene.

3. The method of claim 2, further comprising prior to displaying the immersive MR scene:
displaying the 2D image to the recipient; and
receiving a command from the recipient to display the immersive MR scene.

4. The method of claim 3, wherein the 2D image is displayed on a 2D display screen.

5. The method of claim 1, wherein the recording is a three-dimensional snapshot.

6. The method of claim 1, wherein the recording is a three-dimensional video.

7. The method of claim 6, wherein the recording includes a two-dimensional (2D) video of the immersive MR scene.

8. The method of claim 7, further comprising prior to displaying the immersive MR scene:
displaying the 2D video to the recipient; and
receiving a command from the recipient to display the immersive MR scene.

9. The method of claim 6, further comprising one or more of:
pausing the recording;
slowing the recording;
speeding up the recording; and
scrubbing through the recording.

10. The method of claim 1, further comprising prior to displaying the immersive MR scene:
recreating digital elements of the immersive MR scene that are defined by the data; and
reconstructing real elements of the immersive MR scene that are defined by the data;
wherein the displaying of the immersive MR scene includes displaying the recreated digital elements and reconstructed real elements.

11. The method of claim 1, wherein the immersive MR scene includes a recording of a subject, the method further comprising:
displaying the immersive MR scene to the subject on a further immersive device connected to a further immersive computing system, simultaneously with the displaying of the immersive MR scene to the viewer;
wherein:
the display of the immersive MR scene to the viewer includes a composited live view of the subject; and
the display of the immersive MR scene to the subject includes a composited live view of the viewer.

12. The method of claim 11, further comprising:
compositing a live view of the subject into the display of the immersive MR scene to the viewer; and
compositing a live view of the viewer into the display of the immersive MR scene to the subject.

13. The method of claim 12, further comprising:
transmitting sufficient data, from the immersive computing system to the further immersive computing system, for the further immersive computing system to composite the live view of the viewer into the display of the immersive MR scene to the subject; and
transmitting sufficient data, from the further immersive computing system to the immersive computing system, for the immersive computing system to composite the live view of the subject into the display of the immersive MR scene to the viewer.

14. The method of claim 1, further comprising recording the immersive MR scene.

15. The method of claim 14, wherein the data defines:
a 2D snapshot of the immersive MR scene;
one or more digital elements and one or more real elements in the 2D snapshot;
metadata corresponding to the recording;
coordinate information of a camera used to capture the real elements; and
coordinate information of a virtual camera from which the digital elements are recorded; and
scene state for reconstruction of the scene.

16. The method of claim 15, wherein the data further defines:
field of view and distortion of the camera; and
field of view and distortion of the virtual camera.

17. The method of claim 15, wherein the data further defines a 2D video of the scene.

18. The method of claim 11, further comprising one or more of:
pausing the recording;
slowing the recording;
speeding up the recording; and
scrubbing through the recording;
while maintaining in real time the composited live views of the subject in the display of the MR scene to the viewer and of the viewer in the display of the immersive MR scene to the subject.

19. A non-transitory computer readable medium comprising computer-readable instructions, which, when executed by a processor cause an immersive computing machine to:
receive a recording of an immersive mixed reality (MR) scene, wherein the recording comprises sufficient data to reconstruct multiple different three-dimensional views of the immersive MR scene depending on a perspective of a viewer of the reconstructed immersive MR scene;
display the immersive MR scene to the viewer on an immersive device connected to an immersive computing machine; and
adjust the display of the immersive MR scene from a first perspective to a second perspective as the viewer moves from a first location to a second location in the immersive MR scene.

20. A system for providing experiences of immersive mixed reality (MR) content comprising:
an immersive computing machine;
an immersive device connected to the immersive computing machine; and
a processor configured to:
receive a recording of an immersive MR scene, wherein the recording comprises sufficient data to reconstruct multiple different three-dimensional views of the immersive MR scene depending on a perspective of a viewer of the reconstructed immersive MR scene;
display the immersive MR scene to the viewer on the immersive device; and
adjust the display of the immersive MR scene from a first perspective to a second perspective as the viewer moves from a first location to a second location in the immersive MR scene.
